(19) United States
(12) Patent Application Publication
(10) Pub. No.: US 2010/0246972 A1
(43) Pub. Date: Sep. 30, 2010

(54) IMAGE PROCESSING APPARATUS, IMAGE PROCESSING METHOD, AND RECORDING MEDIUM

(76) Inventors: Noriyuki KOYAMA, Osaka (JP); Mitsuhiro Hakaridani, Osaka (JP)

Correspondence Address: BIRCH STEWART KOLASCH & BIRCH, PO BOX 747, FALLS CHURCH, VA, 22040-0747, US

(21) Appl. No.: 12/729,483

(22) Filed: Mar. 23, 2010

(30) Foreign Application Priority Data
Mar. 24, 2009 (JP) P2009-072928

(51) Int. Cl. G06K 9/48

(52) U.S. Cl. 382/199

(57) ABSTRACT

A reduced edge image generating unit divides into blocks an image indicated by image information inputted by an input device which inputs image information for expressing an image, calculates the luminance values of pixels in each of the divided blocks, and generates a 1/N edge image based on a difference between the luminance value of a block of interest and the luminance value of a block adjacent to the block of interest. An inclination detecting unit performs line scanning on the 1/N edge image, which has been generated by the reduced edge image generating unit, for every angle set beforehand, calculates the evaluation value based on the luminance of a pixel for every line on which the line scanning is performed, calculates the statistical value based on the evaluation value calculated for every line, and estimates the inclination of the image from the calculated statistical value.

### CROSS-REFERENCE TO RELATED APPLICATION

This application claims priority to Japanese Patent Application No. 2009-072928, which was filed on Mar. 24, 2009, the contents of which are incorporated herein by reference in their entirety.

### BACKGROUND OF THE INVENTION

1. Field of the Invention

The present invention relates to an image processing apparatus which detects the inclination of an image indicated by image information inputted by an input device, an image processing method, and a recording medium.

2. Description of the Related Art

In recent years, various applications using a camera have been proposed with the growing rate of a camera-equipped mobile phone. For example, a mobile phone is known in which an application program of photographing a business card with a camera, recognizing characters of an image of the business card photographed by the camera using OCR (Optical Character Reading), and registering the recognition result in a telephone directory of the mobile phone is installed. In addition, a mobile phone is commercially available in which an application program of photographing an image of the store information printed in a magazine or the like and performing OCR processing on the photographed image to extract the information is installed. In many cases, the photographed image of the magazine includes not only the character information but also a photo, and the background of characters is not a solid color but a colorful image.

When photographing an image with a camera-equipped mobile phone, the image is photographed in a state where the mobile phone is gripped. Accordingly, the degree of freedom of the photographing direction is high and the camera position is not stable, compared with the case where an image is read with a scanner. For this reason, when the photographing is performed with a camera-equipped mobile phone, the photographic subject may be photographed in a state of being inclined. However, it is not possible to recognize the inclined image correctly with the normal OCR. Therefore, in order to enable photographing without caring about the inclination of an image and recognition of the characters from the photographed image, it is necessary to detect the inclination of the image beforehand and to correct the image by rotation based on the detected inclination.

As another known technique, for example, in order to detect the inclination of a document image, Japanese Examined Patent Publication JP-B2 2701346 discloses a technique of converting an input image into a binary image, calculating the white run length or black run length of a pixel column along the line for every predetermined angle, and setting as the inclination of the image the angle at which the variance becomes the maximum.

Moreover, as still another known technique, for example, Japanese Unexamined Patent Publication JP-A 6-20093 (1994) discloses a technique of setting as the inclination of an image the angle of a line, at which the sum of black pixels of each line read gradually becomes the maximum, for every predetermined angle.

According to the technique disclosed in JP-B2 2701346 or JP-A 6-20093, the inclination of a document image with only a character can be detected. However, the inclination of an image including a photo cannot be detected. When an input image is converted into a binary image, the feature of a photo part is not expressed in a specific direction, unlike a character part the feature of which is expressed in the character string direction. For the image including a photo, it is difficult to calculate the appropriate white run length or black run length or the sum of black pixels.

Even in the case of an image not including a photo, it is difficult to detect the inclination of the image when the background of characters is not a solid color. For example, when an image having smooth gradation in the background of characters is inputted, the character string of a binary image is not clear. Accordingly, it is difficult to calculate the appropriate white run length or black run length or the sum of black pixels. Thus, in the known techniques, it is difficult to detect the inclination when a photo is included in an image or when the background of characters is not a solid color.

In addition, when the size of an input image is large, the number of pixels read when calculating the white run length, the black run length, or the sum of black pixels is increased. Accordingly, the amount of processing is also increased.

By additionally performing processing of removing a photo from an image and converting the image, from which a photo has been removed, into a binary image, the inclination of the image may also be detected using the technique disclosed in JP-B2 2701346 or JP-A 6-20093. However, since it is necessary to additionally perform the processing of removing a photo from an image, the system becomes complicated and the processing time becomes long.

### SUMMARY OF THE INVENTION

It is an object of the invention to provide an image processing apparatus capable of detecting the inclination of an image without requiring a long processing time even when a photo is included in an image indicated by image information inputted by an input device or when the background of characters is not a solid color, an image processing method, a program, and a recording medium.

The invention provides an image processing apparatus comprising:

an edge image generating section for dividing into blocks an image indicated by image information inputted by an input section for inputting image information for expressing an image, calculating luminance values of pixels in each of the divided blocks, and generating a 1/N edge image based on a difference between a luminance value of a block of interest and a luminance value of a block adjacent to the block of interest; and

an inclination detecting section for performing line scanning on the 1/N edge image, which has been generated by the edge image generating section, for every angle set beforehand, calculating an evaluation value based on a luminance of a pixel for every line on which line scanning is performed, calculating a statistical value based on the evaluation value calculated for every line, and estimating an inclination of the image from the calculated statistical value.

Furthermore, in the invention, it is preferable that a number of black pixels is used as the evaluation value.

Furthermore, in the invention, it is preferable that a maximum value of white run length is used as the evaluation value.

Furthermore, in the invention, it is preferable that a value of variance which is a variance of differences in evaluation value of adjacent lines is used as the statistical value, and the angle at which the statistical value is the maximum is estimated as the inclination of the image.

Furthermore, in the invention, it is preferable that the line scanning is performed with horizontal and vertical directions of the image as reference directions.

Furthermore, the invention provides an image processing method of estimating an inclination of an image processed in an image processing apparatus which detects an inclination of an image, comprising:

an input step of inputting image information for expressing an image;

an edge image generating step of dividing into blocks an image indicated by the image information inputted in the input step, calculating luminance values of pixels in each of the divided blocks, and generating a 1/N edge image based on a difference between a luminance value of a block of interest and a luminance value of a block adjacent to the block of interest; and

an inclination detecting step of performing line scanning on the 1/N edge image, which has been generated in the edge image generating step, for every angle set beforehand, calculating an evaluation value based on a luminance of a pixel for every line on which the line scanning is performed, calculating a statistical value based on the evaluation value calculated for every line, and estimating the inclination of the image from the calculated statistical value.

Furthermore, the invention provides a computer-readable recording medium on which a program of estimating an inclination of an image processed in an image processing apparatus which detects an inclination of an image is recorded, the program making a computer execute:

an input step of inputting image information for expressing an image;

an edge image generating step of dividing into blocks an image indicated by the image information inputted in the input step, calculating the luminance values of pixels in each of the divided blocks, and generating a 1/N edge image based on a difference between the luminance value of a block of interest and the luminance value of a block adjacent to the block of interest; and

an inclination detecting step of performing line scanning on the 1/N edge image, which has been generated in the edge image generating step, for every angle set beforehand, calculating the evaluation value based on the luminance of a pixel for every line on which the line scanning is performed, calculating the statistical value based on the evaluation value calculated for every line, and estimating the inclination of the image from the calculated statistical value.

According to the invention, there are included: an edge image generating section for dividing into blocks an image indicated by image information inputted by an input section for inputting image information for expressing an image, calculating the luminance values of pixels in each of the divided blocks, and generating a 1/N edge image based on a difference between the luminance value of a block of interest and the luminance value of a block adjacent to the block of interest; and an inclination detecting section for performing line scanning on the 1/N edge image, which has been generated by the edge image generating section, for every angle set beforehand, calculating the evaluation value for expressing the edge based on the luminance of a pixel for every line on which the line scanning is performed, calculating the statistical value indicating a difference of the number of edges of each line based on the evaluation value calculated for every line, and estimating the inclination of the image from the calculated statistical value. In this case, the evaluation value is high in a character string in which the edge easily occurs, and the evaluation value is low in a photo part in which the edge is difficult to occur. Accordingly, even when a photo is included in an image or when the background of characters is not a solid color, it is possible to detect the inclination of the image. Furthermore, since the line scanning is performed on the 1/N edge image, the amount of reading of pixels becomes 1/N². As a result, the processing time can be shortened.

### BRIEF DESCRIPTION OF DRAWINGS

Other and further objects, features, and advantages of the invention will be more explicit from the following detailed description taken with reference to the drawings wherein:

FIG. 1 is a block diagram showing an image processing apparatus according to a first embodiment of the invention;

FIG. 2 is a flow chart showing a determination processing of the image processing apparatus;

FIG. 3 is a flow chart showing a reduced edge image generation processing;

FIG. 4 is an image which is an example of an image indicated by image information inputted by an input device;

FIG. 5 is an image obtained by converting the image into a binary image;

FIG. 6 is an image obtained by converting the image to a reduced edge image;

FIG. 7 is a flow chart showing the processing of calculating a statistical value;

FIG. 8 is a view explaining a horizontal line scanning at a line scanning angle D on an image;

FIG. 9 is an image when the image is inclined by −9° by rotating the image by 9° counterclockwise;

FIG. 10 is an image which is another example of the image indicated by the image information inputted by the input device;

FIG. 11 is an image obtained by converting the image into a binary image;

FIG. 12 is an image obtained by converting the image into a reduced edge image; and

FIG. 13 is an image obtained by correcting the inclination angle based on an estimated inclination angle.

### DETAILED DESCRIPTION

Now referring to the drawings, preferred embodiments of the invention are described below.

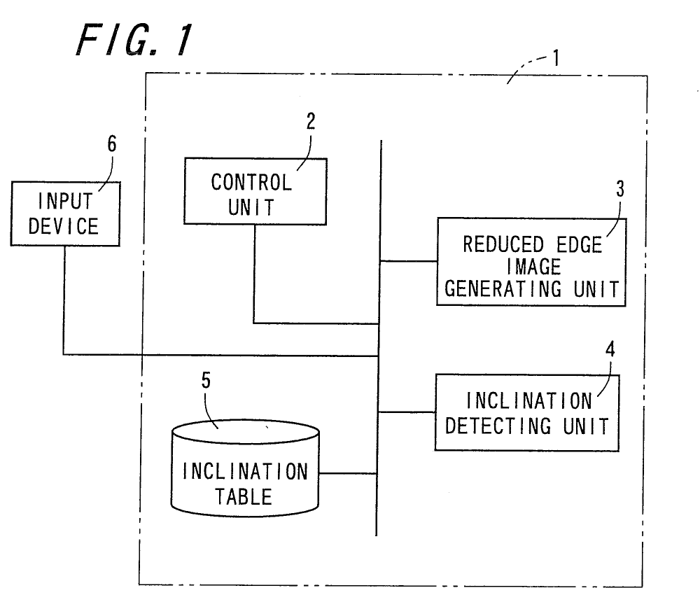

FIG. 1 is a block diagram showing an image processing apparatus 1 according to a first embodiment of the invention. The image processing apparatus 1 includes a control unit 2, a reduced edge image generating unit 3 which is an edge image generating section, an inclination detecting unit 4 which is an inclination detecting section, and an inclination table 5. An input device 6 which is an input section is connected to the image processing apparatus 1. The input device 6 is a device which inputs image information for expressing an image. An image processing method according to the invention is processed by the image processing apparatus 1.

For example, the input device 6 is a CCD (Charge Coupled Device) image sensor or CMOS (Complementary Metal Oxide Semiconductor) image sensor of a mobile phone, digital camera, copying machine, or image scanner. The input device 6 may be a device of reading an image, which has been read by a CCD image sensor, a CMOS image sensor, or the like, from a silicon memory or a magnetic memory in which the image is stored. The input device 6 may be a device for receiving image information located in other computers or storage systems which are connected by cable or wirelessly. The input device 6 is provided outside the image processing apparatus 1 and is configured separately from the image processing apparatus 1. However, the input device 6 may be included in the image processing apparatus 1 without being limited to the above configuration.

The control unit 2 controls the entire image processing apparatus 1. The reduced edge image generating unit 3 divides an image, which is indicated by the image information inputted by the input device 6 for inputting the image information for expressing an image, into blocks with the number of pixels of ‘N×N’, sequentially calculating the average luminance values obtained by averaging the luminance of pixels in each of the divided blocks, and generates a 1/N edge image based on the difference between the average luminance value of a block of interest and the average luminance value of a block calculated immediately before the block of interest.

The inclination detecting unit 4 performs line scanning on the 1/N edge image, which has been generated by the reduced edge image generating unit 3, for every angle set beforehand, calculates the evaluation value based on the luminance of a pixel for every line on which the line scanning is performed, calculates the statistical value based on the evaluation value calculated for every line, and estimates the inclination of the image from the calculated statistical value. Since the inclination detecting unit 4 performs the line scanning on the 1/N edge image, the amount of reading of pixels becomes 1/N². Accordingly, a long processing time is not needed. The inclination table 5 is used when performing the line scanning.

The 1/N edge image includes a black pixel and a white pixel. A black pixel is set when the difference between the average luminance value of a block of interest and the average luminance value of a block calculated immediately before the block of interest is equal to or larger than a threshold value. The evaluation value is calculated using the black pixel number which is the total number of black pixels, for example. The evaluation value may also be calculated using the maximum white run length. The white run length is the number of continuous white pixels, and the maximum white run length is a white run length when the number of continuous white pixels is the maximum.

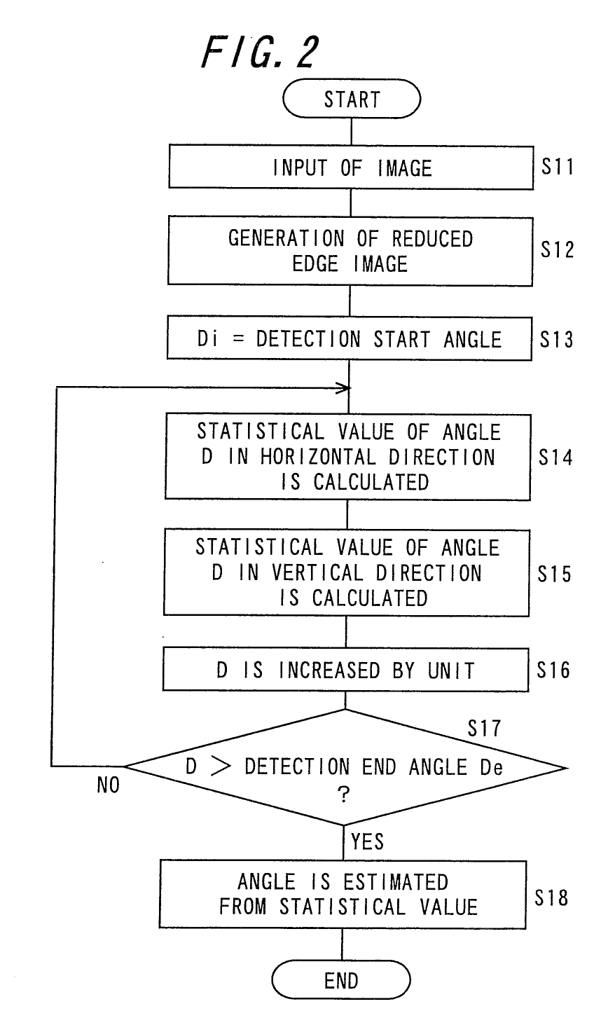

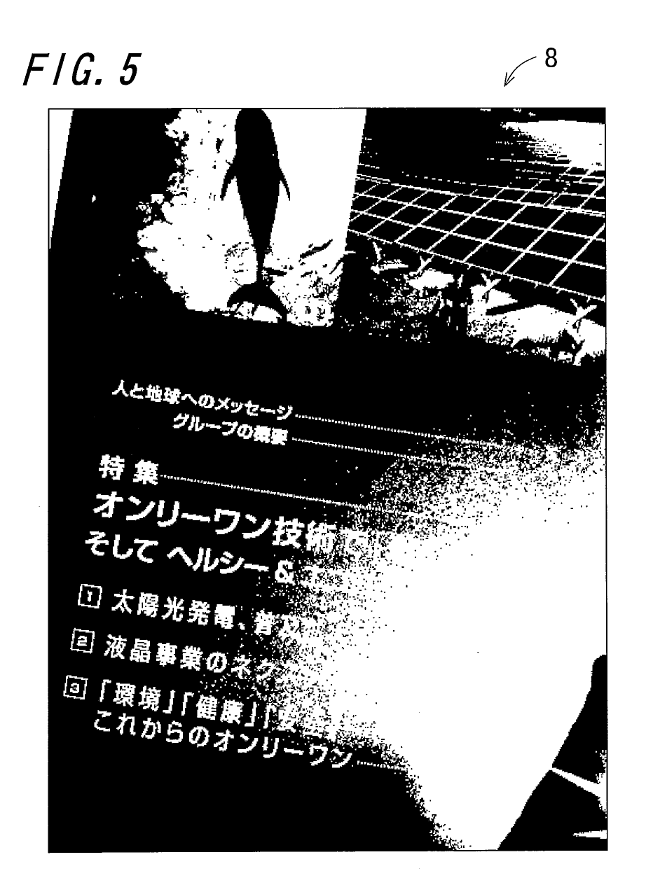

FIG. 2 is a flow chart showing the determination processing of the image processing apparatus 1. In step S11, the input device 6 inputs image information to the image processing apparatus 1. For example, the input device 6 inputs image information on an image 8 shown in FIG. 5. In step S12, the reduced edge image generating unit 3 generates a reduced edge image from the image indicated by the image information input in step S11. This processing will be separately described in detail. In step S13, the inclination detecting unit 4 sets to an inclination detection start angle Di, which is a variable, the inclination angle of an image when starting the image detection for detecting the inclination of the image. For example, the inclination detection start angle Di is −45°. In step S14, the inclination detecting unit 4 calculates the statistical value in a horizontal direction, at the inclination detection start angle Di, for the reduced edge image generated by the reduced edge image generating unit 3 in step S12. By calculating the statistical value in the horizontal direction, it is possible to detect the inclination of a character string which is horizontally written. This processing will be separately described in detail.

In step S15, the inclination detecting unit 4 calculates the statistical value in a vertical direction, at the inclination detection start angle Di, for the reduced edge image generated by the reduced edge image generating unit 3 in step S12. In the processing of step S15, the processing of step S12 which is performed in the horizontal direction of an image is performed in the vertical direction of the image. By calculating the statistical value in the vertical direction, it is possible to detect the inclination of a character string which is vertically written. In step S16, the inclination detecting unit 4 adds an inclination detection unit angle to the inclination detection start angle Di, and the angle obtained by adding the inclination detection unit angle is set as an inclination detection angle D. The inclination detection unit angle indicates a gap between angles at which the inclination detection is performed.

In step S17, the inclination detecting unit 4 determines whether or not the inclination detection angle D is equal to or smaller than an inclination detection end angle De which is an angle set beforehand in order to end the inclination detection. When the inclination detection angle D is equal to or smaller than the inclination detection end angle De, the process returns to step S14. When the inclination detection angle D is larger than the inclination detection end angle De, the process proceeds to step S18. In step S18, the inclination detecting unit 4 estimates, as an inclination angle of the image, the inclination detection angle D with a maximum value among the statistical values calculated in steps S14 and S15.

For example, the inclination detection start angle Di is set to −45°, and the angle at which the inclination of an image is detected is set in a range of −45° to +45°. The inclination detection unit angle is set to 1°. However, the inclination detection unit angle is not limited to this angle. For example, in the case where a scanner or the like is used, the angle at which the inclination of an image is detected may be set in a range of −20° to +20° and the inclination detection unit angle may be set to 2° because the inclination angle of an image is limited.

Since the inclination detection end angle De is +45°, the process proceeds to step S18 when the inclination detection angle D exceeds +45° in step S17. When the inclination detection angle D does not exceed +45°, the process proceeds to step S14. Here, ‘−10°’ indicates that an image is inclined by 10° counterclockwise from the horizontal direction, and ‘+10°’ indicates that an image is inclined by 10° clockwise from the horizontal direction.

Moreover, in general OCR (Optical Character Reading) processing, top and bottom direction determination processing for determining which of the north, south, east, and west of an image is the top in the unit of 90° is performed. Accordingly, in the present embodiment, by combining setting the angle range where the inclination of an image is detected to a range of −45° to +45° with the top and bottom direction determination processing, the OCR processing can be performed even when the image is inclined in any direction.

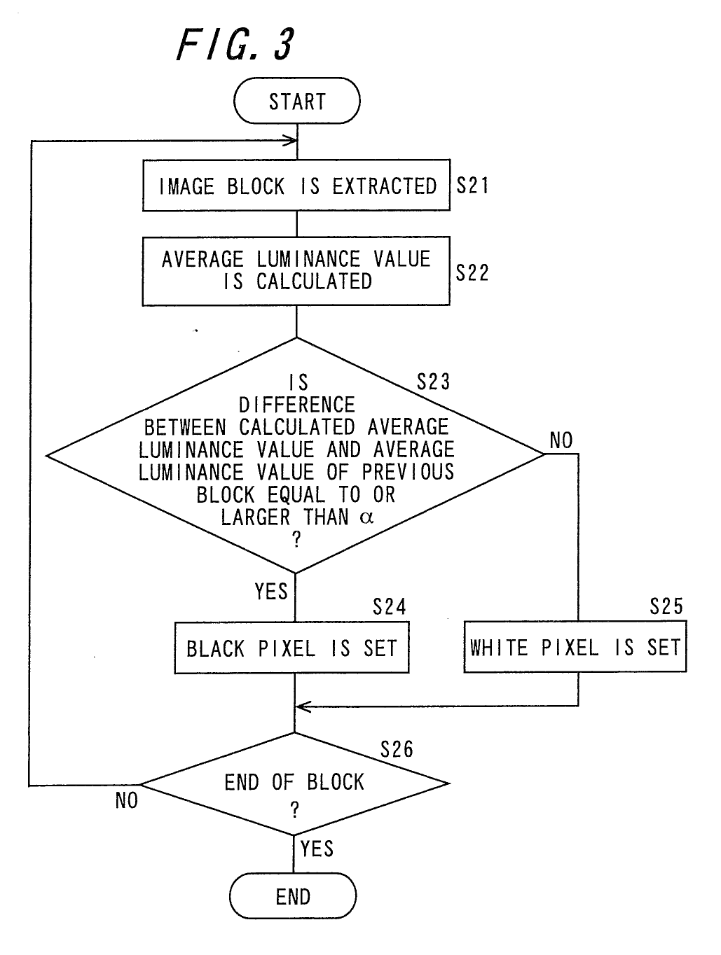

FIG. 3 is a flow chart showing the reduced edge image generation processing. In step S11 shown in FIG. 2, when the input device 6 inputs image information into the image processing apparatus 1, the process proceeds to step S21. In step S21, the reduced edge image generating unit 3 performs processing of sequentially extracting blocks from an image indicated by the inputted image information. In the present embodiment, N is set to 8 and a block with the number of pixels of ‘8×8 ’ is extracted. In addition, the value of N is not limited to 8, and other values may be set. The extracted block is not limited to having a square shape, such as the number of pixels of ‘8×8 ’. For example, the extracted block may be a rectangular block with the number of pixels of ‘8×4 ’.

In step S22, the reduced edge image generating unit 3 performs processing of calculating the average luminance value of the blocks of ‘N×N’ extracted in step S21. When an image indicated by the input image information is expressed with 24 bits of RGB (Red, Green, Blue), the luminance value Y is calculated as Y=0.3×R+0.59×G+0.11×B. Accordingly, the luminance value Y becomes a value of 0 to 255. In addition, when the input image is expressed with YCbCr, the value of Y is a luminance value. The average luminance value can be calculated by extracting the average value of the luminance values of ‘N×N’ pixels included in the target block. In the present embodiment, the average luminance value can be calculated by extracting the average value of the luminance values of (8×8) pixels.

In step S23, the reduced edge image generating unit 3 calculates the difference between the average luminance value of a block of interest calculated in step S22 and the average luminance value of a block calculated immediately before the block of interest. In addition, the reduced edge image generating unit 3 determines whether or not the calculated difference is equal to or larger than more than the threshold value α.

Although the threshold value α is set to 20 in the present embodiment, the threshold value α is not limited thereto. When the calculated difference is equal to or larger than α, the process proceeds to step S24. In step S24, the reduced edge image generating unit 3 set a black pixel since there is an edge between the block of interest and the block calculated immediately before the block of interest. When the calculated difference is smaller than α, the process proceeds to step S25. In step S25, the reduced edge image generating unit 3 set a white pixel since there is no edge between the block of interest and the block calculated immediately before the block of interest.

The reduced edge image generating unit 3 moves to step S26 after setting a black pixel or a white pixel in step S24 or step S25. In step S26, the reduced edge image generating unit 3 determines whether or not all blocks of the image have been extracted. When there is no block in the image, the reduced edge image generating unit 3 ends the processing. When there is a block remaining in the image, the process proceeds to step S21 in which the reduced edge image generating unit 3 continues the processing of extracting a block from the image.

Although the reduced edge image generating unit 3 calculates the average luminance value of each block, calculates the difference between the average luminance value of a block of interest and the average luminance value of a block calculated immediately before the block of interest, and generates a 1/N edge image based on the calculated difference, the invention is not limited thereto. For example, the number of pixels whose luminance values are equal to or smaller than a predetermined value (for example, 50) or the number of pixels whose luminance values are equal to or larger than a predetermined value (for example, 200) is counted for pixels in a block of interest, and the total number of counted numbers is calculated. When a difference between the total number calculated for the block of interest and the total number counted for the block adjacent to the block of interest is equal to or larger than the predetermined value, a black pixel may be set. When the difference is equal to or smaller than the predetermined value, a white pixel may be set, and a 1/N edge image may be generated.

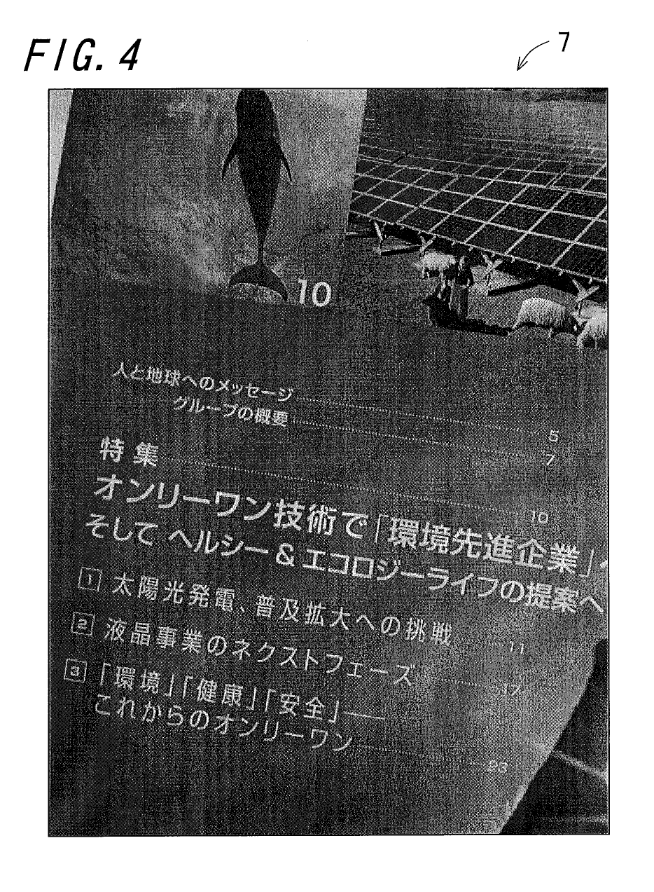

FIG. 4 is an image 7 which is an example of an image indicated by the image information inputted by the input device 6. The background of characters has smooth gradation, and there is a photo above the character string.

FIG. 5 is an image 8 obtained by converting the image 7 into a binary image. Since the character string is not clear, it is not possible to calculate the appropriate white run length or black run length or the sum of black pixels from the binary image.

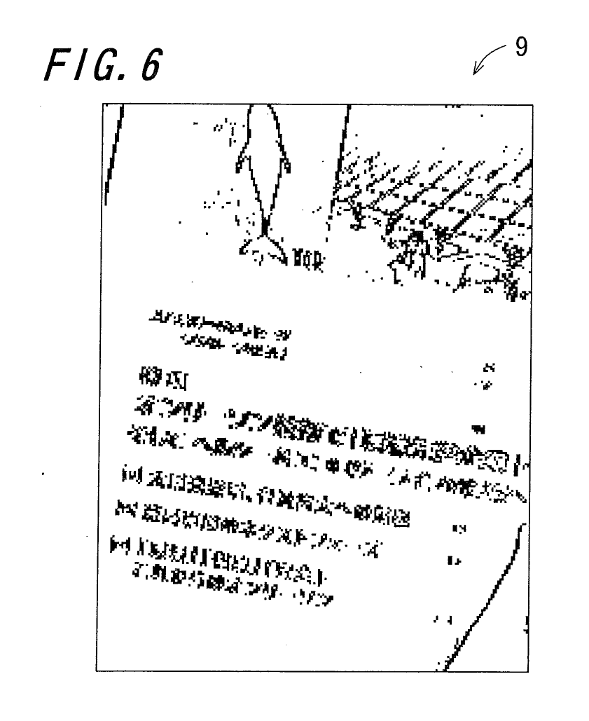

FIG. 6 is a view showing a reduced edge image of the image shown in FIG. 4. There are many edges in a character string, and an edge does not appear between character strings. Unlike a character part, an edge is difficult to appear in a specific direction in a photo part.

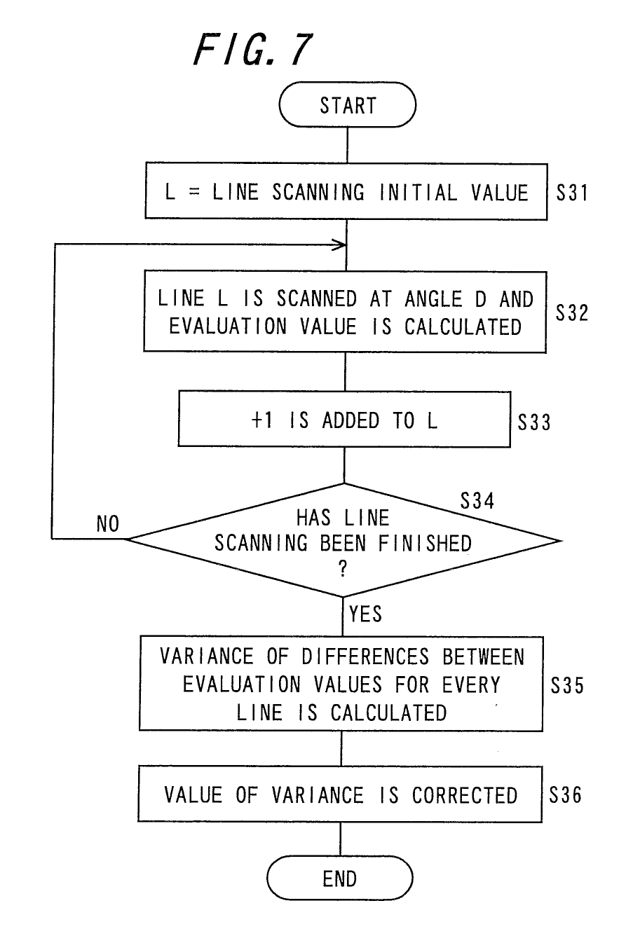

FIG. 7 is a flow chart showing the processing of calculating the statistical value. The inclination detecting unit 4 performs line scanning on the reduced edge image generated in step S12 shown in FIG. 2. In step S31, the inclination detecting unit 4 sets a variable L to “1” by initializing the control counter L when performing the line scanning. In step S32, the inclination detecting unit 4 scans the line L at the angle D and calculates the evaluation value. The number of black pixels is used as the evaluation value.

In step S33, the inclination detecting unit 4 adds “1” to the value of the variable L. In step S34, the inclination detecting unit 4 determines whether or not the line scanning has been finished. In the case of line scanning in the horizontal direction, when the line L reaches the lower end of the reduced edge image, the inclination detecting unit 4 scans the line L and ends the processing. When the line L does not reach the lower end of the reduced edge image, the process returns to step S32 in which the inclination detecting unit 4 scans a line resulting from adding “1” to the value of the variable L and ends the processing.

In step S35, the inclination detecting unit 4 calculates a difference between the evaluation value of a line of interest and the evaluation value of a line, which is calculated immediately before the line of interest, for every line and calculates the value of variance having the absolute value of the difference as an element. For a character string, the value of variance is larger than in a photo part. When the ratio of the variance of the inclination detection angle D from 0° is not equal to or larger than a predetermined value, the angle of rotation may be defined indistinct.

In step S36, the inclination detecting unit 4 corrects the value of variance calculated in step S35 and sets the corrected value of variance as a statistical value. When the reduced edge image is not a square, the inclination detecting unit 4 corrects the reduced edge image based on a difference between the width of the reduced edge image in the horizontal direction and the height of the reduced edge image in the vertical direction.

For the line scanning in the horizontal direction, statistical value=(value of variance)÷(width of reduced edge image)²×100000. For the line scanning in the vertical direction, statistical value=(value of variance)÷(height of reduced edge image)²×100000.

In a character string in which the edge easily occurs, the evaluation value is high since the number of black pixels expressing the edge is large. In a photo part in which the edge is difficult to occur, the evaluation value is low since the number of black pixels expressing the edge is small. Accordingly, even when a photo is included in an image or when the background of characters is not a solid color, it is possible to detect the inclination of the image.

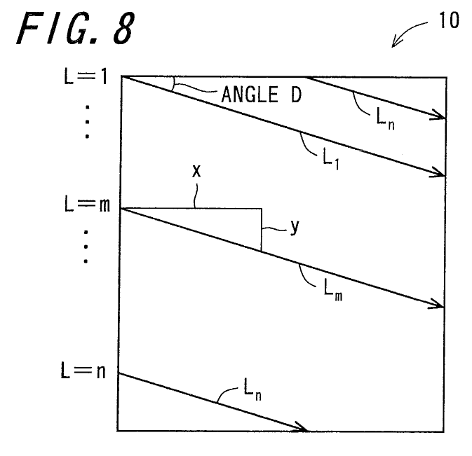

FIG. 8 is a view explaining the horizontal line scanning at the line scanning angle D on an image 10. The line scanning starts at the line L=1. The line L=m indicates an m-th scanning line. In a line L=n which is an n-th scanning line, the line L=n reaches the lower end of an image in the middle of the line scanning. The inclination detecting unit 4 restarts the line scanning from the upper end of the image continuously and performs the line scanning up to the right end of the image. The inclination detecting unit 4 scans the line L=n and ends the processing.

Table 1 shows an inclination table 5. When the inclination detecting unit 4 performs the line scanning, the inclination table 5 is used.

TABLE 1

| | | POSITION | | | | | | | | | | | | | | | | |
|---|---|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 | 15 | 16 |
| ANGLE | 0 | 0 | 0 | 0 | 0 | 0 | 0 | 0 | 0 | 0 | 0 | 0 | 0 | 0 | 0 | 0 | 0 | 0 |
| | 1 | 0 | 0 | 0 | 0 | 0 | 0 | 0 | 0 | 0 | 0 | 0 | 0 | 0 | 0 | 0 | 0 | 0 |
| | 2 | 0 | 0 | 0 | 0 | 0 | 0 | 0 | 0 | 0 | 0 | 0 | 0 | 0 | 0 | 0 | 1 | 1 |
| | 3 | 0 | 0 | 0 | 0 | 0 | 0 | 0 | 0 | 0 | 0 | 1 | 1 | 1 | 1 | 1 | 1 | 1 |
| | 4 | 0 | 0 | 0 | 0 | 0 | 0 | 0 | 0 | 1 | 1 | 1 | 1 | 1 | 1 | 1 | 1 | 1 |
| | 5 | 0 | 0 | 0 | 0 | 0 | 0 | 1 | 1 | 1 | 1 | 1 | 1 | 1 | 1 | 1 | 1 | 1 |
| | 6 | 0 | 0 | 0 | 0 | 0 | 1 | 1 | 1 | 1 | 1 | 1 | 1 | 1 | 1 | 1 | 2 | 2 |
| | 7 | 0 | 0 | 0 | 0 | 0 | 1 | 1 | 1 | 1 | 1 | 1 | 1 | 1 | 2 | 2 | 2 | 2 |
| | 8 | 0 | 0 | 0 | 0 | 1 | 1 | 1 | 1 | 1 | 1 | 1 | 2 | 2 | 2 | 2 | 2 | 2 |
| | 9 | 0 | 0 | 0 | 0 | 1 | 1 | 1 | 1 | 1 | 1 | 2 | 2 | 2 | 2 | 2 | 2 | 3 |
| | 10 | 0 | 0 | 0 | 1 | 1 | 1 | 1 | 1 | 1 | 2 | 2 | 2 | 2 | 2 | 2 | 3 | 3 |
| | . | . | . | . | . | . | . | . | . | . | . | . | . | . | . | . | . | . |
| | . | . | . | . | . | . | . | . | . | . | . | . | . | . | . | . | . | . |
| | . | . | . | . | . | . | . | . | . | . | . | . | . | . | . | . | . | . |

| | | POSITION | | | | | | | | | | | | | |
|---|---|---|---|---|---|---|---|---|---|---|---|---|---|---|---|
| | | 17 | 18 | 19 | 20 | 21 | 22 | 23 | 24 | 25 | 26 | 27 | 28 | 29 | . . . |
| ANGLE | 0 | 0 | 0 | 0 | 0 | 0 | 0 | 0 | 0 | 0 | 0 | 0 | 0 | 0 | . . . |
| | 1 | 0 | 0 | 0 | 0 | 0 | 0 | 0 | 0 | 0 | 0 | 0 | 0 | 1 | . . . |
| | 2 | 1 | 1 | 1 | 1 | 1 | 1 | 1 | 1 | 1 | 1 | 1 | 1 | 1 | . . . |
| | 3 | 1 | 1 | 1 | 1 | 1 | 1 | 1 | 1 | 1 | 1 | 1 | 1 | 2 | . . . |
| | 4 | 1 | 1 | 1 | 1 | 1 | 2 | 2 | 2 | 2 | 2 | 2 | 2 | 2 | . . . |
| | 5 | 1 | 2 | 2 | 2 | 2 | 2 | 2 | 2 | 2 | 2 | 2 | 2 | 3 | . . . |
| | 6 | 2 | 2 | 2 | 2 | 2 | 2 | 2 | 3 | 3 | 3 | 3 | 3 | 3 | . . . |
| | 7 | 2 | 2 | 2 | 2 | 3 | 3 | 3 | 3 | 3 | 3 | 3 | 3 | 4 | . . . |
| | 8 | 2 | 3 | 3 | 3 | 3 | 3 | 3 | 3 | 4 | 4 | 4 | 4 | 4 | . . . |
| | 9 | 3 | 3 | 3 | 3 | 3 | 3 | 4 | 4 | 4 | 4 | 4 | 4 | 5 | . . . |
| | 10 | 3 | 3 | 3 | 4 | 4 | 4 | 4 | 4 | 4 | 4 | 5 | 5 | 5 | . . . |
| | . | . | . | . | . | . | . | . | . | . | . | . | . | . | . |
| | . | . | . | . | . | . | . | . | . | . | . | . | . | . | . |
| | . | . | . | . | . | . | . | . | . | . | . | . | . | . | . |

By using the inclination table 5, the inclination detecting unit 4 does not need to perform the calculation of tangent (tan). Accordingly, the speed of inclination detection processing can be improved. The inclination table 5 shows the scanning position y at the position x at the angle D shown in FIG. 8. For example, when the angle is 8°, it can be seen that the scanning position y at the position x=20 is 3.

Table 2 is a view showing the maximum statistical value for every inclination detection angle. The image indicated by the image information shown in FIG. 4 is converted into a reduced edge image in step S12 shown in FIG. 2. The inclination detecting unit 4 outputs the statistical value by processing in steps S13 to S17.

TABLE 2

| | Statistical value in | Statistical value in |
|---|---|---|
| Angle D | horizontal direction | vertical direction |
| −45 | 32 | 24 |
| −44 | 24 | 16 |
| −43 | 37 | 15 |
| −42 | 35 | 19 |
| −41 | 29 | 16 |
| −40 | 18 | 21 |
| −39 | 35 | 18 |
| −38 | 29 | 13 |
| −37 | 29 | 15 |
| −36 | 27 | 24 |
| −35 | 35 | 18 |
| −34 | 32 | 22 |
| −33 | 29 | 22 |
| −32 | 27 | 22 |
| −31 | 27 | 18 |
| −30 | 35 | 15 |
| −29 | 27 | 24 |
| −28 | 29 | 22 |
| −27 | 32 | 21 |
| −26 | 27 | 16 |
| −25 | 27 | 22 |
| −24 | 18 | 16 |
| −23 | 18 | 18 |
| −22 | 27 | 21 |
| −21 | 24 | 18 |
| −20 | 32 | 18 |
| −19 | 29 | 18 |
| −18 | 24 | 22 |
| −17 | 27 | 24 |
| −16 | 32 | 21 |
| −15 | 24 | 36 |
| −14 | 16 | 35 |
| −13 | 24 | 33 |
| −12 | 29 | 28 |
| −11 | 27 | 30 |
| −10 | 21 | 25 |
| −9 | 27 | 22 |
| −8 | 24 | 24 |
| −7 | 21 | 27 |
| −6 | 29 | 27 |
| −5 | 18 | 21 |
| −4 | 21 | 35 |
| −3 | 27 | 30 |
| −2 | 32 | 33 |
| −1 | 24 | 33 |
| 0 | 27 | 33 |
| 1 | 27 | 25 |
| 2 | 27 | 22 |
| 3 | 24 | 32 |
| 4 | 46 | 32 |
| 5 | 51 | 38 |
| 6 | 59 | 44 |
| 7 | 86 | 32 |
| 8 | 146 | 64 |
| 9 | 192 | 73 |
| 10 | 146 | 54 |
| 11 | 94 | 62 |
| 12 | 70 | 50 |
| 13 | 78 | 36 |
| 14 | 59 | 39 |
| 15 | 51 | 35 |
| 16 | 43 | 36 |
| 17 | 32 | 35 |
| 18 | 35 | 32 |
| 19 | 32 | 28 |
| 20 | 24 | 32 |
| 21 | 29 | 24 |
| 22 | 27 | 27 |
| 23 | 18 | 22 |
| 24 | 18 | 25 |
| 25 | 24 | 25 |
| 26 | 27 | 21 |
| 27 | 27 | 25 |
| 28 | 18 | 21 |
| 29 | 18 | 22 |
| 30 | 21 | 32 |
| 31 | 24 | 35 |
| 32 | 24 | 33 |
| 33 | 21 | 28 |
| 34 | 18 | 27 |
| 35 | 21 | 19 |
| 36 | 21 | 24 |
| 37 | 24 | 22 |
| 38 | 27 | 12 |
| 39 | 18 | 18 |
| 40 | 29 | 16 |
| 41 | 18 | 24 |
| 42 | 18 | 25 |
| 43 | 18 | 22 |
| 44 | 27 | 16 |
| 45 | 18 | 30 |

According to Table 2, the maximum statistical value in the horizontal direction for every inclination detection angle is “192”. The inclination detection angle D of the maximum statistical value “192” is 9°. Accordingly, 9° which is the inclination detection angle D is estimated as the inclination angle of an image.

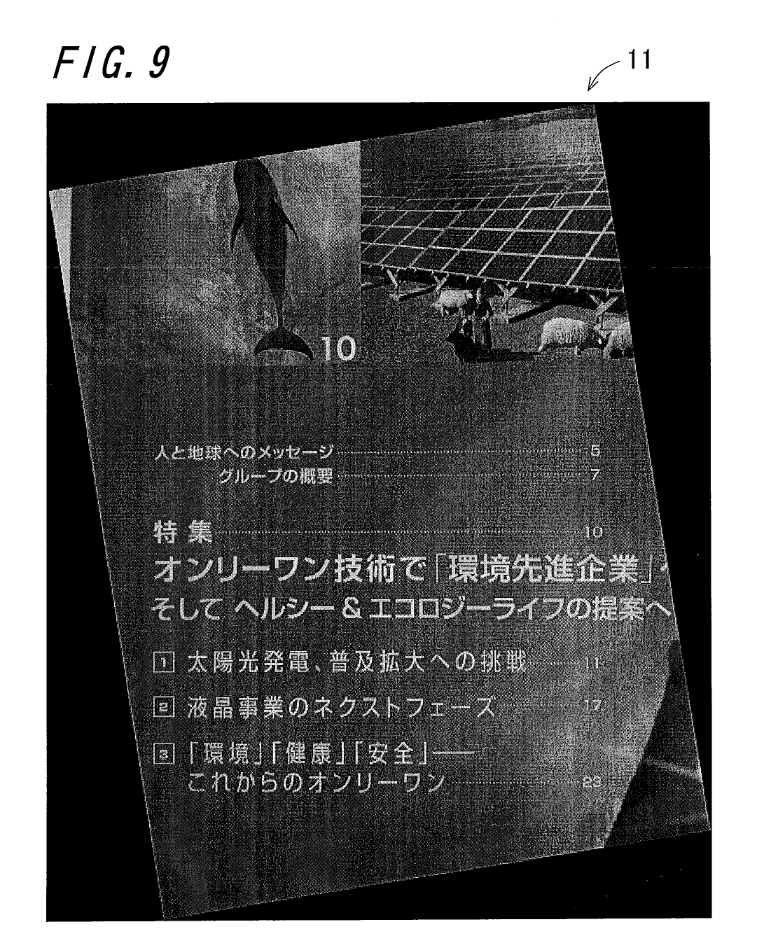

FIG. 9 is an image 11 when the image 7 is inclined by −9° by rotating the image 7 by 9° counterclockwise. It can be seen that the character string of the image shown in FIG. 9 is aligned in the horizontal direction and the estimated inclination angle of 9° is equal to the actual inclination angle. Moreover, in the processing in step S32 shown in FIG. 7, the number of black pixels has been used as the evaluation value of the line scanning. However, the maximum white run length may also be used as the evaluation value of the line scanning.

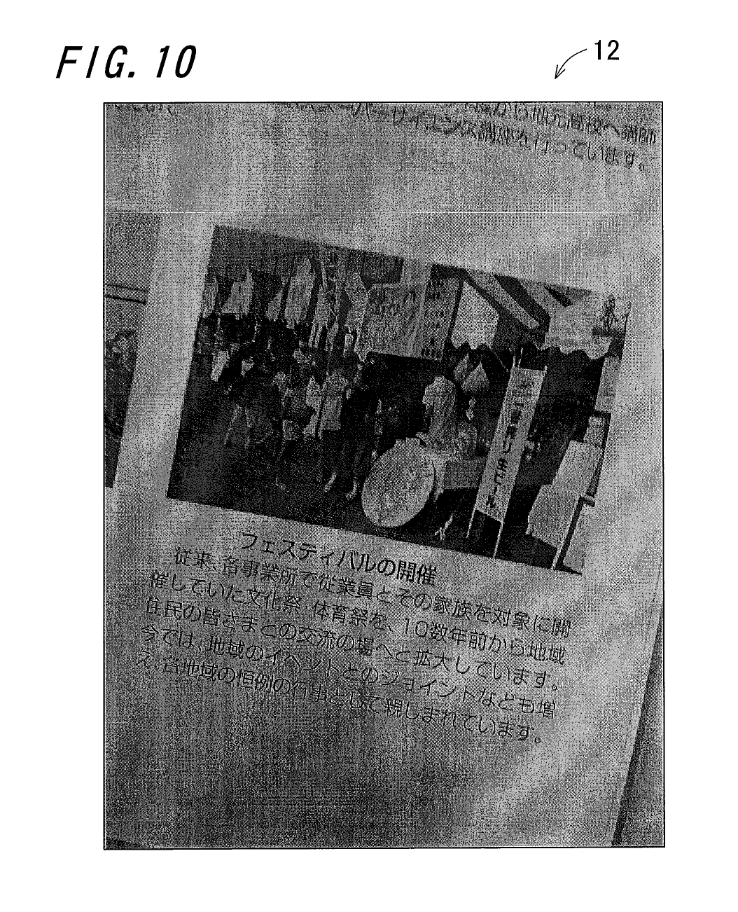

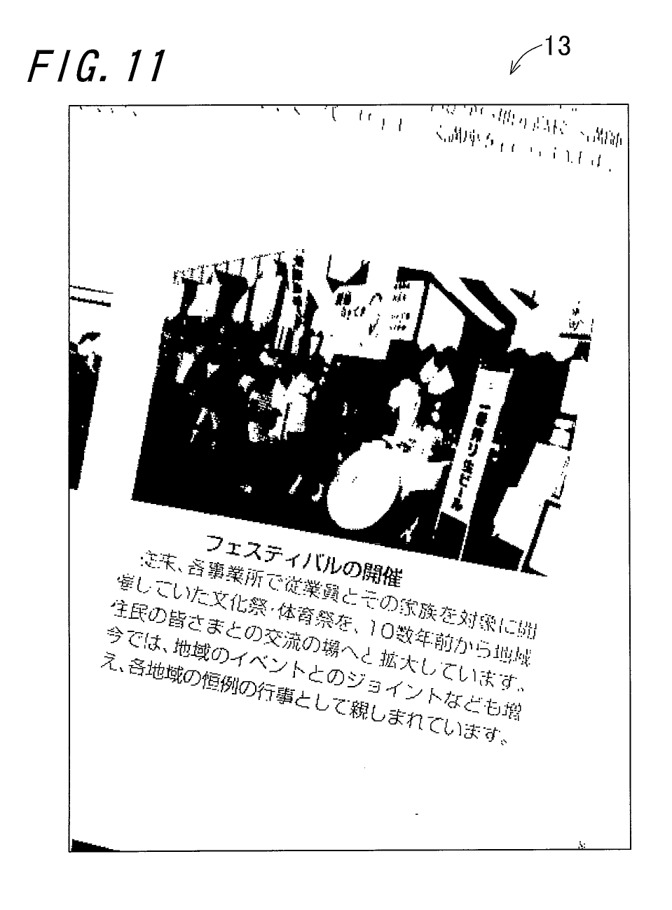

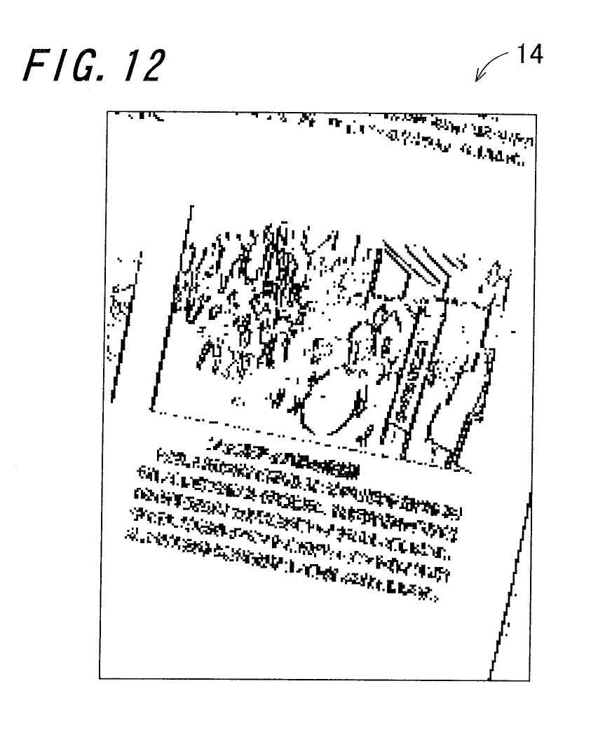

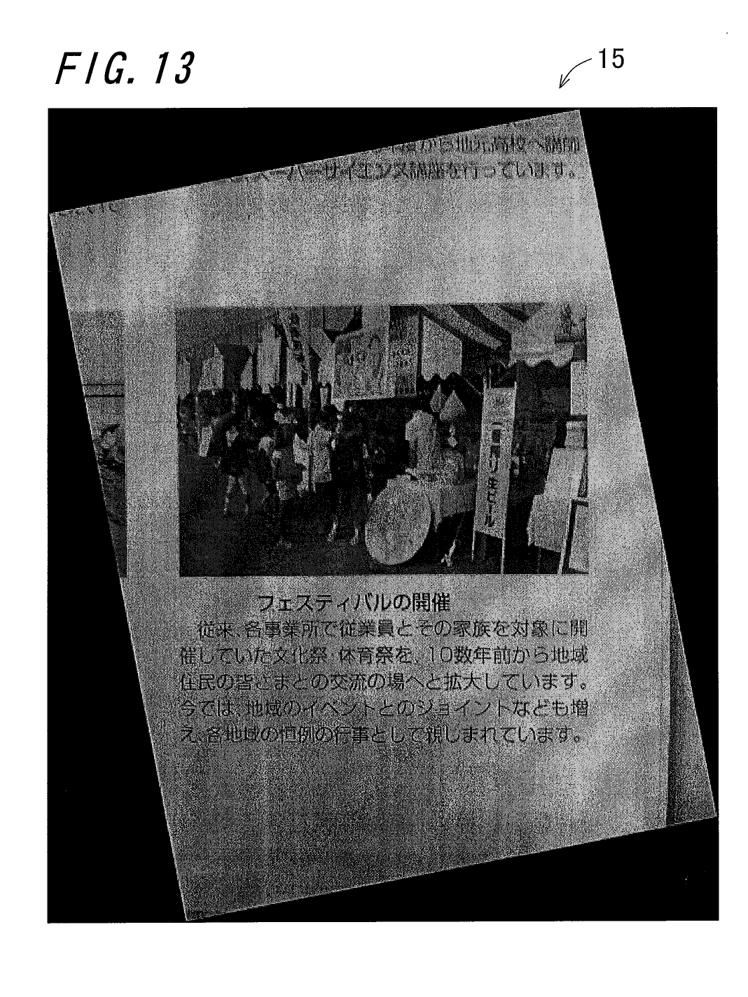

FIG. 10 is an image 12 which is another example of the image indicated by the image information inputted by the input device 6. The image includes a photo and characters. FIG. 11 is an image 13 obtained by converting the image 12 into a binary image. The image 12 shown in FIG. 10 is converted into a binary image in order to generate a reduced edge image. FIG. 12 is an image 14 obtained by converting the image 12 into a reduced edge image. In a character part of the image, there are many edges in a character string and an edge does not appear between character strings. In a photo part, an edge is difficult to appear in a specific direction unlike the character part. FIG. 13 is an image 15 obtained by correcting the inclination angle based on the estimated inclination angle. It can be seen that the character string of the image shown in FIG. 13 is aligned in the horizontal direction and the estimated inclination angle is equal to the actual inclination angle.

Table 3 shows a result when the detection rate of the inclination was evaluated using the variance of the number of black pixels as the evaluation value. From a magazine or the like, 439 document images which include photos and are not inclined are taken out. The extracted document images are rotated beforehand in the unit of 10° in a range of −40° to −10° and a range of 10° to 40°, whereas the extracted document images are rotated beforehand in the unit of 5° in a range of −10° to 10°. Using a total of 4829 rotated images as evaluation images, it was evaluated whether or not the inclination of the evaluation images set beforehand was correctly detected.

TABLE 3

| | Total | | | | | | |
|---|---|---|---|---|---|---|---|
| | number | Correct | | Wrong | | Indistinct | |
| −40° | 439 | 436 | 99.3% | 3 | 0.7% | 0 | 0.0% |
| −30° | 439 | 437 | 99.5% | 2 | 0.5% | 0 | 0.0% |
| −20° | 439 | 437 | 99.5% | 2 | 0.5% | 0 | 0.0% |
| −10° | 439 | 438 | 99.8% | 1 | 0.2% | 0 | 0.0% |
| −5° | 439 | 439 | 100.0% | 0 | 0.0% | 0 | 0.0% |
| 0° | 439 | 439 | 100.0% | 0 | 0.0% | 0 | 0.0% |
| 5° | 439 | 439 | 100.0% | 0 | 0.0% | 0 | 0.0% |
| 10° | 439 | 437 | 99.5% | 2 | 0.5% | 0 | 0.0% |
| 20° | 439 | 438 | 99.8% | 1 | 0.2% | 0 | 0.0% |
| 30° | 439 | 437 | 99.5% | 2 | 0.5% | 0 | 0.0% |
| 40° | 439 | 438 | 99.8% | 1 | 0.2% | 0 | 0.0% |
| Total | 4829 | 4815 | 99.7% | 14 | 0.3% | 0 | 0.0% |

The inclination of 99.7% of the total of 4829 evaluation images was correctly detected. This result tells the effectiveness of the present embodiment in which the inclination of an image can be precisely detected.

Table 4 shows a result when the evaluation for the same image as the image used in Table 3 was performed with the evaluation value at the time of line scanning as the maximum white run length.

TABLE 4

| | Total | | | | | | |
|---|---|---|---|---|---|---|---|
| | number | Correct | | Wrong | | Indistinct | |
| −40° | 439 | 416 | 94.8% | 20 | 4.6% | 3 | 0.7% |
| −30° | 439 | 427 | 97.3% | 12 | 2.7% | 0 | 0.0% |
| −20° | 439 | 427 | 97.3% | 11 | 2.5% | 1 | 0.2% |
| −10° | 439 | 423 | 96.4% | 15 | 3.4% | 1 | 0.2% |
| −5° | 439 | 438 | 99.8% | 1 | 0.2% | 0 | 0.0% |
| 0° | 439 | 435 | 99.1% | 4 | 0.9% | 0 | 0.0% |
| 5° | 439 | 430 | 97.9% | 9 | 2.1% | 0 | 0.0% |
| 10° | 439 | 425 | 96.8% | 14 | 3.2% | 0 | 0.0% |
| 20° | 439 | 421 | 95.9% | 18 | 4.1% | 0 | 0.0% |
| 30° | 439 | 427 | 97.3% | 11 | 2.5% | 1 | 0.2% |
| 40° | 439 | 415 | 94.5% | 23 | 5.2% | 1 | 0.2% |
| Total | 4829 | 4684 | 97.0% | 138 | 2.9% | 7 | 0.1% |

The inclination of 97.0% of the total of 4829 evaluation images was correctly detected. This result tells the effectiveness of the present embodiment in which the inclination of an image can be precisely detected, similar to the case where the number of black pixels is used.

Thus, according to the invention, even in the case of a document image in which a photo or the like is included in an image, the inclination of the image can be detected by using the statistical value based on the value of variance of the variations of edges of a reduced edge image.

The image processing apparatus 1 is formed by a computer, for example. The computer which forms the image processing apparatus 1 includes an input device, an output device, a storage device, and a central processing unit (hereinafter, referred to as a “CPU”).

The input device which is an input section is formed by a keyboard or a mouse, for example, and inputs the information. The output device which is a display section is formed by a display device such as a liquid crystal display or a printing device such as a printer, for example, and outputs the information. The storage device is formed by a semiconductor memory or a hard disk drive unit, for example, and stores a program of controlling the image processing apparatus 1 and data required to control the image processing apparatus 1.

The CPU controls the input device and the output unit by executing the program stored in the storage device and realizes the functions of the reduced edge image generating unit 3, inclination detecting unit 4, inclination table, and the like. Since the computer which forms the image processing apparatus 1 is a computer which is generally used, a detailed explanation thereof will be omitted.

In the embodiment described above, a program is stored in a storage device of a computer, for example, in a storage device such as a semiconductor memory or a hard disk drive unit. However, the program may be recorded in a computer-readable recording medium without being limited to those described above. The recording medium may be a recording medium which can be read when inserted into a program reader provided as an external storage device (not shown) or may be a storage device of another apparatus, for example.

In any case, it is preferable that a program stored in the recording medium is accessed and executed by a computer. Moreover, in any case, it is preferable that a program is read from the recording medium, the read program is stored in a program storage area of a storage device, and the program is executed. In addition, a program may be downloaded from another apparatus through a communication network and stored in the program storage area. A download program is stored beforehand in the storage device of the computer or installed in the program storage area from another recording medium.

For example, the recording medium which is formed detachably from the main body may be a tape type recording medium such as a magnetic tape and a cassette tape, a disk type recording medium such as magnetic disks including a flexible disk and a hard disk and optical disks including a CD-ROM (Compact Disk Read Only Memory), an MO (Magneto Optical disk), an MD (Mini Disc), and a DVD (Digital Versatile Disk), a card type recording medium such as an IC (Integrated Circuit) card (including a memory card) and an optical card, or a recording medium which includes a semiconductor memory and carries a fixed program, such as a mask ROM, an EPROM (Erasable Programmable Read Only Memory), an EEPROM (Electrically Erasable Programmable Read Only Memory), and a flash ROM. Accordingly, the invention may be provided as a computer-readable recording medium in which a program of causing a computer to execute each step of the image processing method is recorded.

As described above, the image processing apparatus 1 of the embodiment includes the reduced edge image generating unit 3 that divides into blocks an image indicated by image information inputted by an input device 6 which inputs image information for expressing an image, calculating the luminance values of pixels in each of the divided blocks, and generating a 1/N edge image based on a difference between the luminance value of a block of interest and the luminance value of a block adjacent to the block of interest; and an inclination detecting unit 4 that performs line scanning on the 1/N edge image, which has been generated by the reduced edge image generating unit 3, for every angle set beforehand, calculating the evaluation value for expressing the edge based on the luminance of a pixel for every line on which the line scanning is performed, calculating the statistical value indicating a difference of the number of edges of each line based on the evaluation value calculated for every line, and estimating the inclination of the image from the calculated statistical value. In this case, the evaluation value is high in a character string in which the edge easily occurs, and the evaluation value is low in a photo part in which the edge is difficult to occur. Accordingly, even when a photo is included in an image or when the background of characters is not a solid color, it is possible to detect the inclination of the image. In addition, since the line scanning is performed on the 1/N edge image, the amount of reading of pixels becomes 1/N². As a result, the processing time can be shortened.

In addition, since the number of black pixels is used as the evaluation value, it is possible to precisely detect the inclination of an image.

In addition, since the maximum value of white run length is used as the evaluation value, it is possible to precisely detect the inclination of an image.

In addition, the value of variance which is the variance of the difference of each evaluation value of an adjacent line is used as the statistical value and the angle, at which the statistical value is the maximum, is estimated as the inclination of an image. Accordingly, the evaluation value is high in a character string in which the edge easily occurs, and the evaluation value is low in a photo part in which the edge is difficult to occur. As a result, even when a photo is included in an image or when the background of characters is not a solid color, it is possible to detect the inclination of the image.

In addition, the line scanning is performed with the horizontal and vertical directions of an image as reference directions. Accordingly, by calculating the statistical value in the horizontal and vertical directions, it is possible to detect the inclination of a character string which is written horizontally and vertically.

In addition, the image processing method of the embodiment includes an input step S11 of inputting image information for expressing an image; an edge image generating step S12 of dividing into blocks an image indicated by the image information inputted in the input step S11, calculating the luminance values of pixels in each of the divided blocks, and generating a 1/N edge image based on a difference between the luminance value of a block of interest and the luminance value of a block adjacent to the block of interest; and an inclination detecting step S18 of performing line scanning on the 1/N edge image, which has been generated in the edge image generating step S12, for every angle set beforehand, calculating the evaluation value for expressing the edge based on the luminance of a pixel for every line on which the line scanning is performed, calculating the statistical value indicating a difference of the number of edges of each line based on the evaluation value calculated for every line, and estimating the inclination of the image from the calculated statistical value. In this case, the evaluation value is high in a character string in which the edge easily occurs, and the evaluation value is low in a photo part in which the edge is difficult to occur. As a result, even when a photo is included in an image or when the background of characters is not a solid color, it is possible to detect the inclination of the image. In addition, since the line scanning is performed on the 1/N edge image, the amount of reading of pixels becomes 1/N². As a result, it is possible to provide an image processing method which does not need a long processing time.

In addition, the computer program of the embodiment makes a computer execute: an input step S11 of inputting image information for expressing an image; an edge image generating step S12 of dividing into blocks an image indicated by the image information inputted in the input step S11, calculating the luminance values of pixels in each of the divided blocks, and generating a 1/N edge image based on a difference between the luminance value of a block of interest and the luminance value of a block adjacent to the block of interest; and an inclination detecting step S18 of performing line scanning on the 1/N edge image, which has been generated in the edge image generating step S12, for every angle set beforehand, calculating the evaluation value for expressing the edge based on the luminance of a pixel for every line on which the line scanning is performed, calculating the statistical value indicating a difference of the number of edges of each line based on the evaluation value calculated for every line, and estimating the inclination of the image from the calculated statistical value. In this case, the evaluation value is high in a character string in which the edge easily occurs, and the evaluation value is low in a photo part in which the edge is difficult to occur. As a result, even when a photo is included in an image or when the background of characters is not a solid color, it is possible to detect the inclination of the image. In addition, since the line scanning is performed on the 1/N edge image, the amount of reading of pixels becomes 1/N². As a result, it is possible to provide a program which does not need a long processing time.

In addition, it is possible to provide a computer-readable recording medium on which the program is recorded.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An image processing apparatus comprising:
an edge image generating section for dividing into blocks an image indicated by image information inputted by an input section for inputting image information for expressing an image, calculating luminance values of pixels in each of the divided blocks, and generating a 1/N edge image based on a difference between a luminance value of a block of interest and a luminance value of a block adjacent to the block of interest; and
an inclination detecting section for performing line scanning on the 1/N edge image, which has been generated by the edge image generating section, for every angle set beforehand, calculating an evaluation value based on a luminance of a pixel for every line on which line scanning is performed, calculating a statistical value based on the evaluation value calculated for every line, and estimating an inclination of the image from the calculated statistical value.

2. The image processing apparatus of claim 1, wherein a number of black pixels is used as the evaluation value.

3. The image processing apparatus of claim 1, wherein a maximum value of white run length is used as the evaluation value.

4. The image processing apparatus of claim 1, wherein a value of variance which is a variance of differences in evaluation value of adjacent lines is used as the statistical value, and the angle at which the statistical value is the maximum is estimated as the inclination of the image.

5. The image processing apparatus of claim 1, wherein the line scanning is performed with horizontal and vertical directions of the image as reference directions.

6. An image processing method of estimating an inclination of an image processed in an image processing apparatus which detects an inclination of an image, comprising:
an input step of inputting image information for expressing an image;
an edge image generating step of dividing into blocks an image indicated by the image information inputted in the input step, calculating luminance values of pixels in each of the divided blocks, and generating a 1/N edge image based on a difference between a luminance value of a block of interest and a luminance value of a block adjacent to the block of interest; and
an inclination detecting step of performing line scanning on the 1/N edge image, which has been generated in the edge image generating step, for every angle set beforehand, calculating an evaluation value based on a luminance of a pixel for every line on which the line scanning is performed, calculating a statistical value based on the evaluation value calculated for every line, and estimating the inclination of the image from the calculated statistical value.

7. A computer-readable recording medium on which a program of estimating an inclination of an image processed in an image processing apparatus which detects an inclination of an image is recorded, the program making a computer execute:
an input step of inputting image information for expressing an image;
an edge image generating step of dividing into blocks an image indicated by the image information inputted in the input step, calculating the luminance values of pixels in each of the divided blocks, and generating a 1/N edge image based on a difference between the luminance value of a block of interest and the luminance value of a block adjacent to the block of interest; and
an inclination detecting step of performing line scanning on the 1/N edge image, which has been generated in the edge image generating step, for every angle set beforehand, calculating the evaluation value based on the luminance of a pixel for every line on which the line scanning is performed, calculating the statistical value based on the evaluation value calculated for every line, and estimating the inclination of the image from the calculated statistical value.
